(19) United States
(12) Patent Application Publication
(10) Pub. No.: US 2015/0184833 A1
(43) Pub. Date: Jul. 2, 2015

(54) Tungsten-Filament-Like Light-Emitting Diode Lamp Structure

(71) Applicant: Ming-Che Wu, Taipei City (TW)

(72) Inventor: Ming-Che Wu, Taipei City (TW)

(21) Appl. No.: 14/141,853

(22) Filed: Dec. 27, 2013

(51) Int. Cl. F21V 13/12; F21K 99/00; F21V 29/00

(52) U.S. Cl. CPC F21V 13/12; F21V 29/22; F21K 9/50; F21Y 2101/02

(57) ABSTRACT

A tungsten-filament-like LED lamp structure includes a lamp shade, a heat dissipating frame, a lamp holder, a LED substrate, a LED light source and a light spreader assembly. The light spreader assembly includes a reflective device and a diverging element, wherein light rays transmitting through a light-permeable portion of the reflective device are diverged by the diverging element to generate frontward lighting, and reflective surfaces of the reflective device control the reflected light rays to generate sideward lighting and backward lighting and thus generate an optical field similar to that of a conventional tungsten filament lamp. Thus, the properties of energy saving, vibration resistant and long lifetime better than those of the conventional lamp can be achieved, and the invention can be directly applied to the conventional lamp structure to decrease the production and maintenance costs.

### BACKGROUND OF THE INVENTION

(1) Field of the Invention

The invention relates to a light-emitting diode (LED) lamp, and more particularly to a tungsten-filament-like LED lamp structure, which can emit light rays with the properties similar to those of the conventional tungsten filament lamp, can be widely applied to various lamp structures, and can also be directly mounted to a receptacle adapted to the conventional tungsten filament lamp.

(2) Description of the Prior Art

A light-emitting diode (LED) is an electrical semiconductor element capable of emitting light rays. With the rapid enhancement of the recent semiconductor industry technology, the manufacturing cost of the LED has been effectively decreased and the LED light source has the better properties, such as the higher vibration resistant property and the longer lifetime, than the conventional light source. At present, the LEDs have been widely applied to the frequently seen illumination appliance in the daily life.

The LED is a planar light source, emits light only in a hemispheric manner and has a light emission angle smaller than 180 degrees. A conventional tungsten filament lamp is a rod-like light source, and has the wide light emission angle that may be greater than 270 degrees. Therefore, in the structure of the LED lamp, if the light source property with the light emission angle the same as that of the conventional tungsten filament lamp is to be obtained, many LEDs have to be combined to enlarge the light emission angle. Since multiple light sources are combined together, it is difficult to decrease the electrical energy consumption. In addition, because the light-emitting positions and the light-emitting surfaces have the larger size, the light ray emitting angles are different from one another or cannot overlap with one another after the light sources are used in conjunction with an optical lamp system. Alternatively, the larger light-emitting surface makes the light rays become less concentrated. Thus, differences may occur when the optical field is being viewed.

Furthermore, due to different light source properties of the LEDs, the LEDs cannot be directly applied to the lamp structure of the conventional light source (e.g., the structure of a vehicle lamp) in many conditions. At present, among various LED vehicle lamp structures available in the market, the optical structure of the vehicle lamp holder is improved to match with the property of the LED light source and to satisfy the use requirement of the vehicle lamp. Thus, when the user wants to replace the conventional tungsten filament vehicle lamp with the LED vehicle lamp, the optical structure associated with the vehicle lamp holder must also be replaced. Thus, the cost cannot be effectively decreased in the aspect of either the production or the use of the vehicle lamp.

In view of the associated problems induced by the design defects of the prior arts, the present inventor has paid attention to the research and development as well as the design on the structure of the LED lamp according to the experience and the technology in the optical field for many years, and thus developed this invention after comparing the optical filed of the conventional tungsten filament light source with the optical field of the spreading of the LED light source and after many tries and improvements.

### SUMMARY OF THE INVENTION

In view of the above-mentioned problems, the invention provides a tungsten-filament-like LED lamp structure having the advantage that one single LED is used to form the optical property similar to that of the tungsten filament lamp, and to generate the optical field and visual effects similar to those of the tungsten filament lamp, thereby decreasing the manufacturing cost and having the energy saving effect.

Furthermore, the invention provides a tungsten-filament-like LED lamp structure, which can be directly applied to the lamp with the conventional lamp specification to lengthen the lifetime of the lamp. In addition, only a single component needs to be replaced, so that the use and replacement become extremely convenient, and the cost of maintaining the lamp can be saved.

To achieve the above-mentioned effects, the tungsten-filament-like LED lamp structure of the invention mainly includes a LED substrate, a LED light source, a heat dissipating frame, a lamp shade, a lamp holder and a light spreader assembly. A bottom surface of the LED substrate is combined with a top portion of the heat dissipating frame. The LED light source is disposed on a surface of the LED substrate. A bottom portion of the lamp shade is combined with the heat dissipating frame so that the LED substrate is disposed in the lamp shade. The lamp holder is combined with a bottom portion of the heat dissipating frame. A circuit board electrically connected to the LED substrate is disposed in the lamp holder. The light spreader assembly is combined with a combination portion of a top portion of the lamp shade, and is mainly for spreading light rays, emitted from the LED light source, to have a light-emitting property similar to that of a tungsten filament light source. The light spreader assembly includes a reflective device and a diverging element. The reflective device is disposed above the LED substrate, has a light-permeable portion at a position corresponding to the LED light source, and has a plurality of reflective surfaces disposed between the light-permeable portion and a periphery of the reflective device. The diverging element is disposed above the reflective device and is for diverging an angle of light rays emitted from the light-permeable portion.

In the tungsten-filament-like LED lamp structure, the light spreader assembly can diverge the planar light source of the LED into the light source similar to the tungsten filament rod-like light source, and can generate the similar optical field so that the user has the same visual effect. In addition, the external designs of the lamp shade and the lamp holder are correspondingly utilized so that the invention can be widely applied to the lamp with the conventional bulb, and the extremely convenient application is obtained. Furthermore, the recent LED has been developed toward the high-power package, and the total light generated by the single LED light source can exceed the conventional vehicle or home lamp. Using the single LED light source of the invention can save the cost and increase the yield as compared with the light source structure having a plurality of LEDs.

According to the above-mentioned structure, each of the reflective surfaces may be an outwardly projecting camber, a concave camber or a plane, and the number of the reflective surfaces may preferably range from 2 to 8.

According to the above-mentioned structure, the reflective surface or each of the reflective surfaces near the light-permeable portion is preferably the outwardly projecting camber. The main reason is because the incident light has the higher intensity at the location closer to the LED light source, and the reflective surface can increase the diffusing angles of the reflected light rays, control the reflected light rays to travel sideward, and prevent the reflected light rays from being shaded by the LED substrate. On the contrary, the reflective surface or each of the reflective surfaces near the periphery of the reflective device is preferably the concave camber. This is because the incident light has the weaker intensity at the location further from the LED light source, and the diffusing angles of the reflected light rays need to be decreased. Due to the position condition, the reflected light rays cannot be easily shaded by the LED substrate, so the reflected light rays are mainly controlled to travel backward. Also, the light-permeable portion may rest against or extremely approximate (with a gap ranging from 0.1 to 2 mm) the top end of the LED light source to assist in fixing the LED light source and to keep the continuous light-emitting property of the single light source.

According to the above-mentioned structure, in order to match with the direction of the light rays emitted from the optical system (reflective device), the heat dissipating frame may be a substantially conical bracket to prevent the light ray shading effect from decreasing the light emitting efficiency of the lamp. Furthermore, the heat dissipating frame has a plurality of heat dissipating layers between the top portion and the bottom portion to enhance the heat dissipating effect. An outer diameter of each heat dissipating layer is relatively smaller than an outer diameter of the heat dissipating layer therebelow.

According to the above-mentioned structure, the LED light source may further include a primary LED light source and a plurality of secondary LED light sources to constitute a two-stage lamp structure applied to, for example, a direction indicator, a brake lamp and the like. It is possible to use the geometric differences of the light sources between the light-emitting position and the light-emitting surface to increase the visual light-pattern changes, and thus to enhance the dynamic warning effect.

The primary LED light source is disposed at a middle of the LED substrate and corresponds to the light-permeable portion. The secondary LED light sources are disposed around the primary LED light source in an equally spaced manner.

According to the above-mentioned structure, the light-permeable portion may be a circular or elliptic through hole or transparent layer.

According to the above-mentioned structure, the bottom portion of the lamp shade is formed with a positioning hole for fitting with and being fixed to the heat dissipating frame.

According to the above-mentioned structure, the combination portion is a receptacle, which extends inwardly from the top portion of the lamp shade and is for accommodating the light spreader assembly. The combination portion includes at least one fitting slot for fitting with the reflective device or the diverging element.

According to the above-mentioned structure, the diverging element may be combined with a corresponding position of the top portion of the lamp shade, and the lamp shade may be composed of a left lamp shell and a right lamp shell.

According to the above-mentioned structure, the lamp shade may be composed of a housing and a cover assembled together, wherein the combination portion is located at a position corresponding to the cover, and the diverging element may be combined with the cover.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a schematically decomposed illustration showing a structure according to an embodiment of the invention;

FIG. 2 is a schematically cross-sectional view showing a structure according to the embodiment of the invention;

FIG. 3 is a schematically side view showing a reflective device according to the embodiment of the invention;

FIGS. 4A and 4B are schematic illustrations showing the exterior of the reflective device according to the embodiment of the invention;

FIGS. 5A to 5C are schematic illustrations showing the exterior of a LED light source according to the embodiment of the invention;

FIG. 6 is a schematic illustration showing a structure of a combined lamp shade of the invention;

FIG. 7 is a schematic illustration showing a structure of another combined lamp shade of the invention;

FIG. 8 is a schematically cross-sectional view showing a structure of another combined lamp shade of the invention;

FIG. 9 is a schematic illustration showing the light ray distribution of the embodiment of the invention;

FIG. 10 is a schematic illustration showing that the embodiment of the invention is applicable to a lamp reflector;

FIG. 11 is a schematic illustration of the simulated isocandela diagram of a tungsten filament lamp applicable to the lamp reflector; and

FIG. 12 is a schematic illustration of the simulated isocandela diagram of the embodiment of the invention applicable to the lamp reflector.

### DETAILED DESCRIPTION OF THE PREFERRED EMBODIMENTS

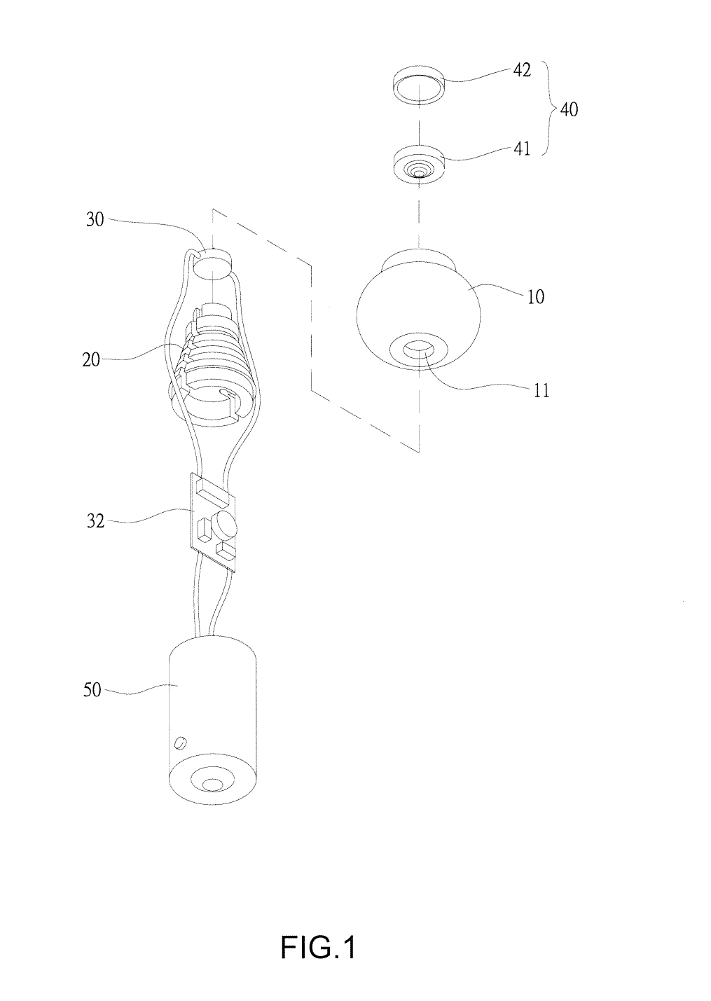

Referring to FIG. 1, a tungsten-filament-like light-emitting diode (LED) lamp structure of this embodiment includes a lamp shade 10, a heat dissipating frame 20, a LED substrate 30, a light spreader assembly 40 and a lamp holder 50. The lamp shade 10 has a bottom portion formed with a positioning hole 11 for fitting with and being combined with the heat dissipating frame 20. The bottom portion of the heat dissipating frame 20 is combined with the top portion of the lamp holder 50. The LED substrate 30 is combined with the top portion of the heat dissipating frame 20, is disposed in the lamp shade 10, and is electrically connected to a circuit board 32 in the lamp holder 50 through traces. The light spreader assembly 40 is combined with the top portion of the lamp shade 10.

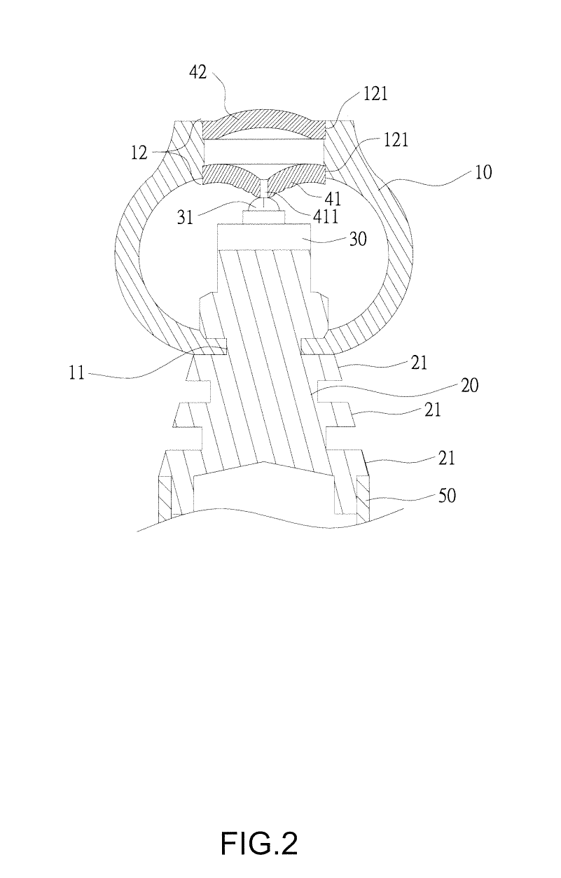

Referring to FIGS. 1 and 2, a LED light source 31 is disposed on the surface of the LED substrate 30, and the light spreader assembly 40 is disposed on a combination portion 12 of the top portion of the lamp shade 10 relatively to the LED substrate 30, and is for emitting the light rays, emitted from the LED light source 31, to have the light-emitting property similar to that of the tungsten filament light source. The light spreader assembly 40 includes a reflective device 41 and a diverging element 42. The combination portion 12 of the top portion of the lamp shade 10 is a receptacle, which extends inwardly from the top portion of the lamp shade 10 and is for accommodating the light spreader assembly 40. The combination portion 12 has at least one fitting slot 121 for fitting or fixing the reflective device 41 or the diverging element 42. The reflective device 41 is disposed between the LED substrate 30 and the diverging element 42, has a light-permeable portion 411 at a position corresponding to the LED light source 31, and has a plurality of reflective surfaces 412 between the light-permeable portion 411 and the periphery of the reflective device 41. The diverging element 42 is disposed above the reflective device 41, is made of a highly light-permeable material and has a plurality of optical curved surfaces for controlling the diffusing angle of the light rays emitted through the light-permeable portion 411, enlarging the half-power angle in front of the main optical axis and forming the frontward lighting.

The heat dissipating frame 20 is to be combined with the lamp shade 10 and the lamp holder 50, and has a top portion, a bottom portion and a plurality of heat dissipating layers 21 disposed between the top portion and the bottom portion. The heat dissipating layers 21 can be disposed longitudinally or transversally according to the model of the lamp. In this embodiment, the heat dissipating layers 21 are disposed transversally so as to enhance the heat dissipating effect. Furthermore, in order to satisfy the requirement of the vehicle lamp and to consider the relative space relative to the lamp, the heat dissipating frame 20 may be disposed in conjunction with the above optical assembly of the LED light source 31 and the light spreader assembly 40. As shown in this embodiment, the heat dissipating frame 20 may be a substantially conical bracket to avoid the shading of the light rays emitted from the light spreader assembly 40 and to thereby increase the light output efficiency. Thus, each of the transversally arranged heat dissipating layers 21 has an outer diameter relatively smaller than the outer diameter of the heat dissipating layer 21 therebelow. In addition, when no special requirement on the light source is present, the model of each of the heat dissipating frames 20 may change in correspondence with the lamp model. For example, in order to match with the lamp having the water drop model, the outer diameter of each of the heat dissipating layers 21 of the heat dissipating frame 20 may be relatively greater than the outer diameter of the heat dissipating layer 21 therebelow.

Regarding to the structure of the reflective surface 412 of the reflective device 41, as shown in AG. 3, in order to effectively control the reflected light rays to match with the corresponding position of each assembly, the reflective surfaces 412 may be a frequently seen plane, or an outwardly projecting camber or a concave camber to achieve the effect of effectively controlling the reflected light rays. According to the result of the practical application, the number of the reflective surfaces 412 preferably ranges from 2 to 8. Also, FIGS. 4A and 4B are schematic illustrations showing the exterior of the reflective device 41 of this embodiment. In order to form the effect the same as the conventional tungsten filament rod-like light source, the light-permeable portion 411 may have a circular or elliptic model to generate the optical field the same as the rod-like tungsten filament light source according to the length of the tungsten filament. In this embodiment, the light-permeable portion 411 is a through hole structure. However, according to the practical application condition, the light-permeable portion 411 may also be a transparent layer made of a highly light-permeable material to achieve the effect of transmitting the light rays. So, it is to be noted that the through hole structure does not intend to restrict the scope of the light-permeable portion 411 of this embodiment.

In the structure of this embodiment, the circuit board 32 converts the power to the converted power, which is suitable for the driving of the LED and transferred to the LED substrate 30 to drive the LED light source 31 on the LED substrate 30 to emit light rays. The reflective device 41 abuts upon and is disposed above the LED light source 31. In this embodiment, the light-permeable portion 411 rests against or extremely approximates (with a gap ranging from about 0.1 to 2 mm) the top end of the LED light source 31, to assist in fixing the LED light source 31 and keep the continuous light-emitting property of the single light source. Therefore, the light rays emitted from the top of the LED light source can directly transmit through the light-permeable portion 411, and then the diverging element 42 diverges the angle of the light rays to form the frontward lighting of the lamp. The reflective surfaces 412 of the reflective device 41 arranged from the light-permeable portion 411 to the periphery thereof control the light rays, which are emitted from other portions of the LED light source 31 and are reflected by the reflective surfaces 412 to form the sideward lighting and backward lighting. Thus, the light spreader assembly 40 can diverge the light-emitting angle of the single plane LED light source 31, which is smaller than 180 degrees, into a wide angle greater than 270 degrees, can thus effectively overcome the problem that the conventional LED lamp module has the insufficient light-emitting angle, and can further have the higher energy saving effect than that of the LED lamp composed of multiple light sources.

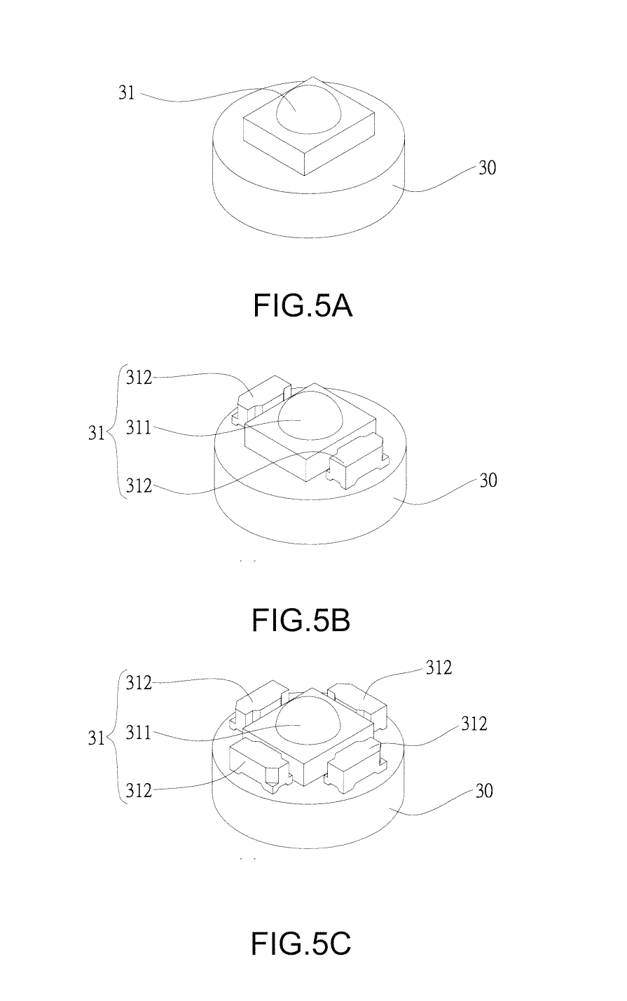

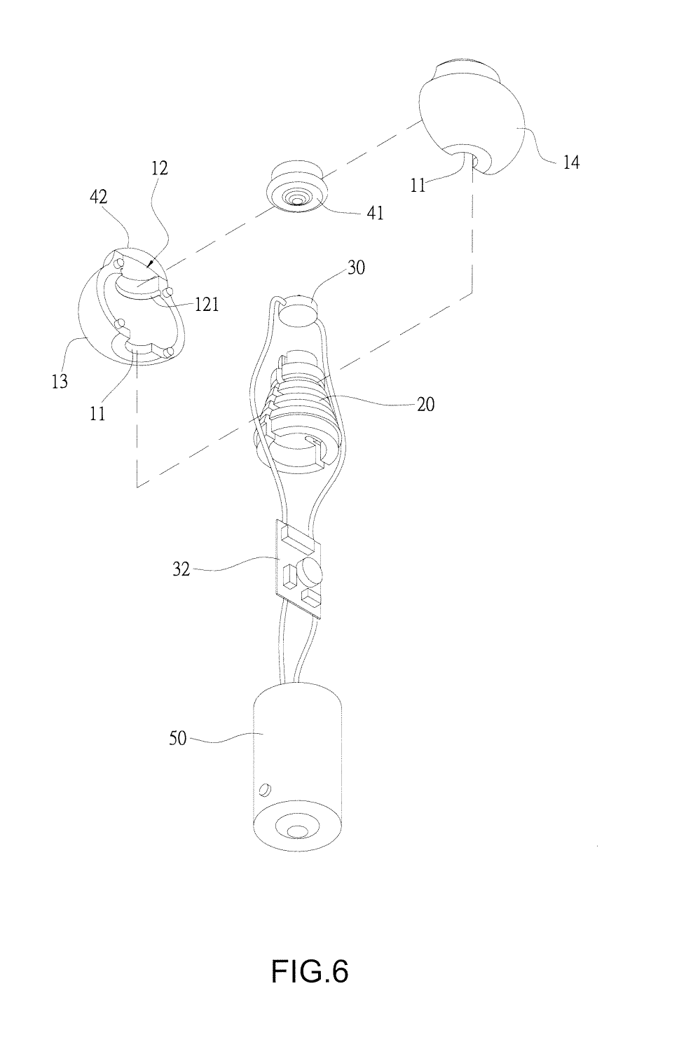

Referring further to FIGS. 5A to 5C, a multi-stage lamp structure is formed by increasing the number of the light sources according to the condition in use. As shown in FIG. 5A, one single primary LED light source 311 forms the LED light source 31. As shown in FIG. 5B, the LED light source 31 includes one primary LED light source 311 and two secondary LED light sources 312. As shown in FIG. 5C, the LED light source 31 includes one primary LED light source 311 and four secondary LED light sources 312. Thus, according to the user's requirement, the secondary LED light sources 312 are arranged around the primary LED light source 311 in an equally spaced manner. Accordingly, it is possible to use the geometric differences of the light sources between the light-emitting position and the light-emitting surface, corresponding to the lamp's optical system, to generate the out-of-focus effect, to enlarge the geometric size of the light-emitting surface, to change the distribution of the light-emitting angle of the lamp, to increase the visual light-pattern changes, and thus to enhance the dynamic warning effect.

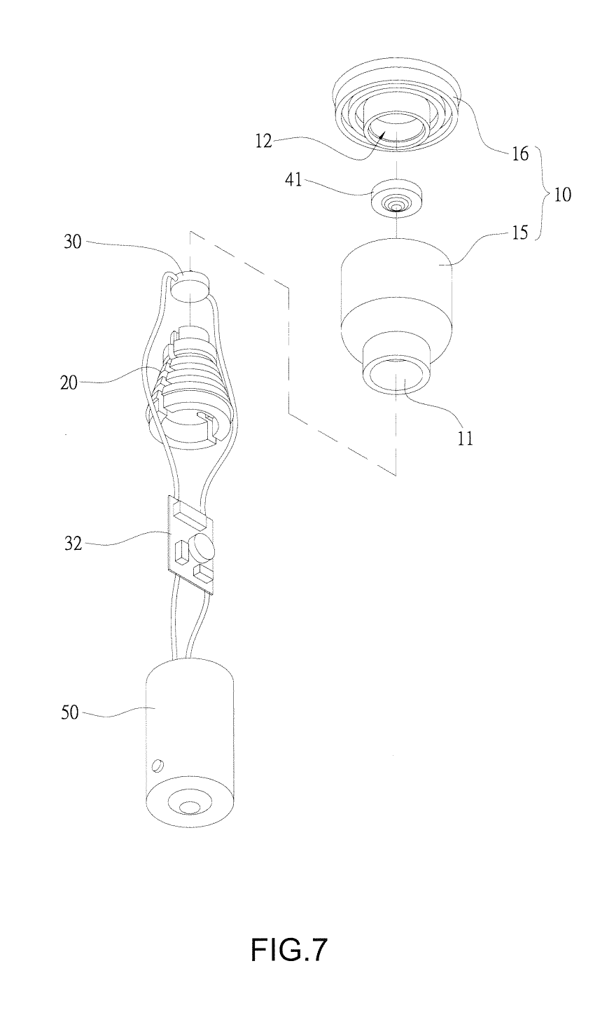

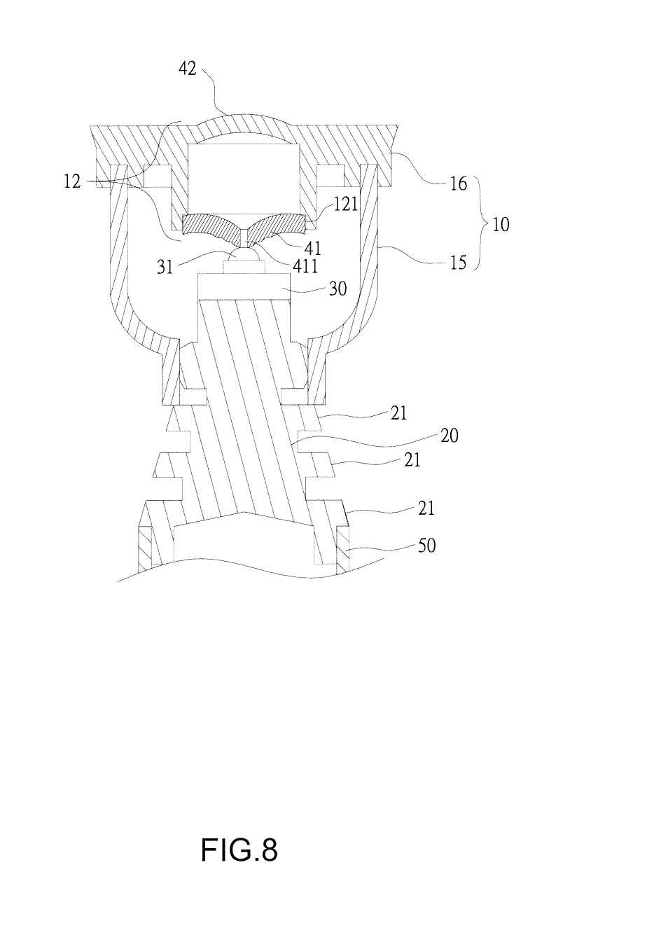

As shown in the structure of AG. 6, the lamp shade 10 of this embodiment according to the exterior of the lamp may be composed of a left lamp shell 13 and a right lamp shell 14 combined together by way of tongues, the diverging element 42 may be an integrally formed structure combined with the top portion of the lamp shade 10, and the reflective device 41 is disposed on the combination portion 12, which is formed on the top portion of the lamp shade 10 and extends downwards. Referring to FIGS. 7 and 8, the lamp shade 10 may also be configured as a structure composed of a housing 15 and a cover 16 combined together. In this structure, the positioning hole 11 is disposed on the bottom portion of the housing 15 and for fitting with the heat dissipating frame 20. The cover 16 is combined with and disposed above the housing 15, and the combination portion 12 is located at the position corresponding to the cover 16 and includes the receptacle. The receptacle is formed from the top portion to the flange of the cover 16 and is to be combined with the light spreader assembly 40. In this embodiment, the diverging element 42 is combined with and disposed on the cover 16, and the reflective device 41 is fit with the fitting slot 121 formed on the flange and rests against or extremely approximates (with a gap ranging from about 0.1 to 2 mm) the top end of the LED light source 31.

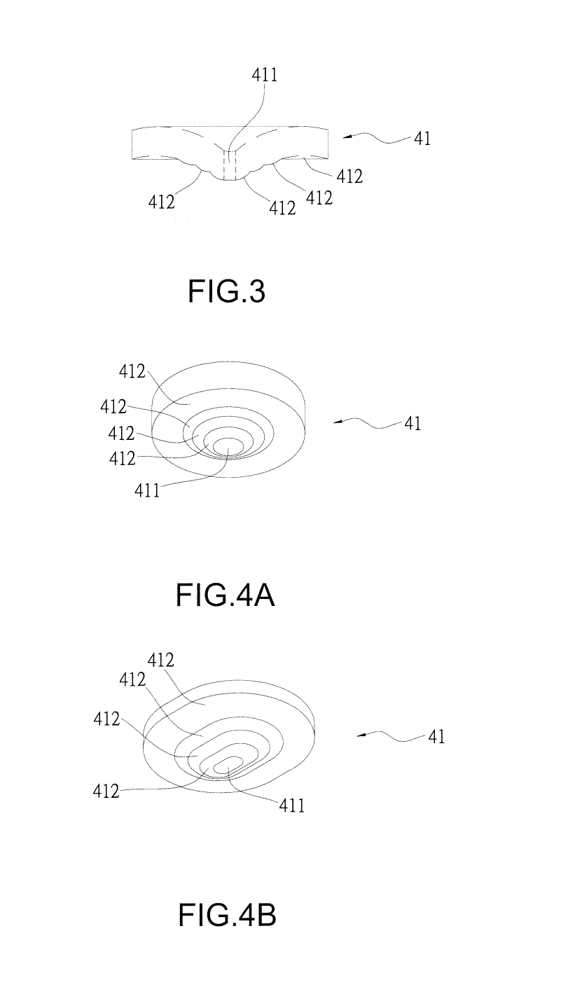

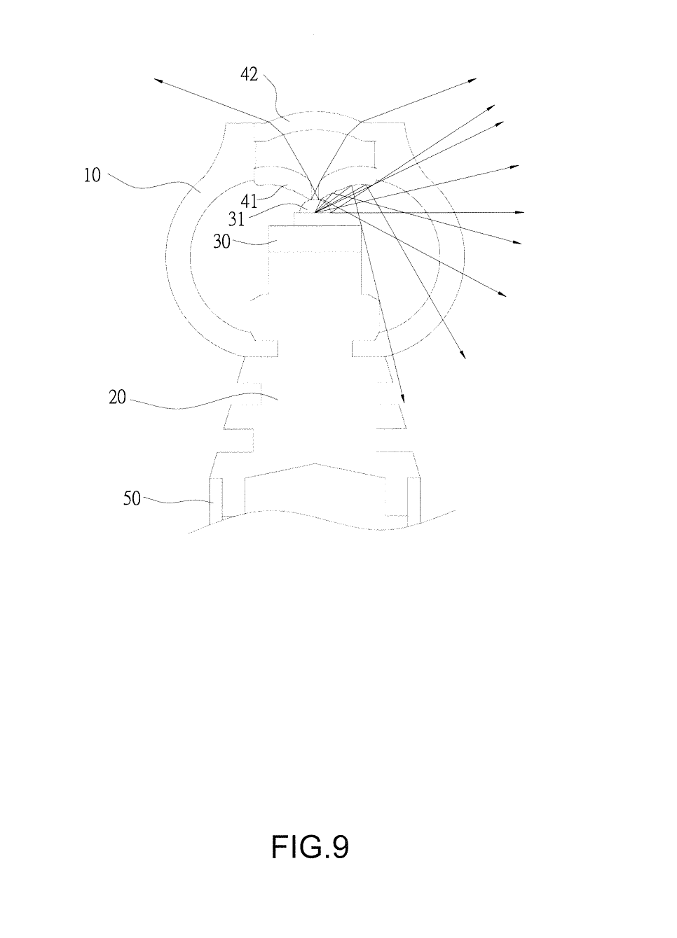

Please refer again to the structure of the reflective device 41 shown in FIG. 3 in conjunction with FIG. 9, which is a schematic illustration showing the light ray distribution according to the embodiment of the invention. It is obtained, from the drawings, that the light rays of the LED light source 31 travelling forwards transmit through the light-permeable portion 411 of the reflective device 41, and the diverging element 42 enlarges the range of the illuminating angle of the frontward lighting light rays. The side-lighting light rays mainly fall within the direct output angular range of the LED light source 31, which is not shaded by an object. The light rays of the LED light source 31, outputted by the reflection of the reflective device 41, include the backward lighting angle, and the angle may be extended to an angle where the light rays are shaded by the heat dissipating frame 20. Meanwhile, the utilization of the concave and convex designs of the reflective surface 412 may also cover the light-emitting angle to the lateral side.

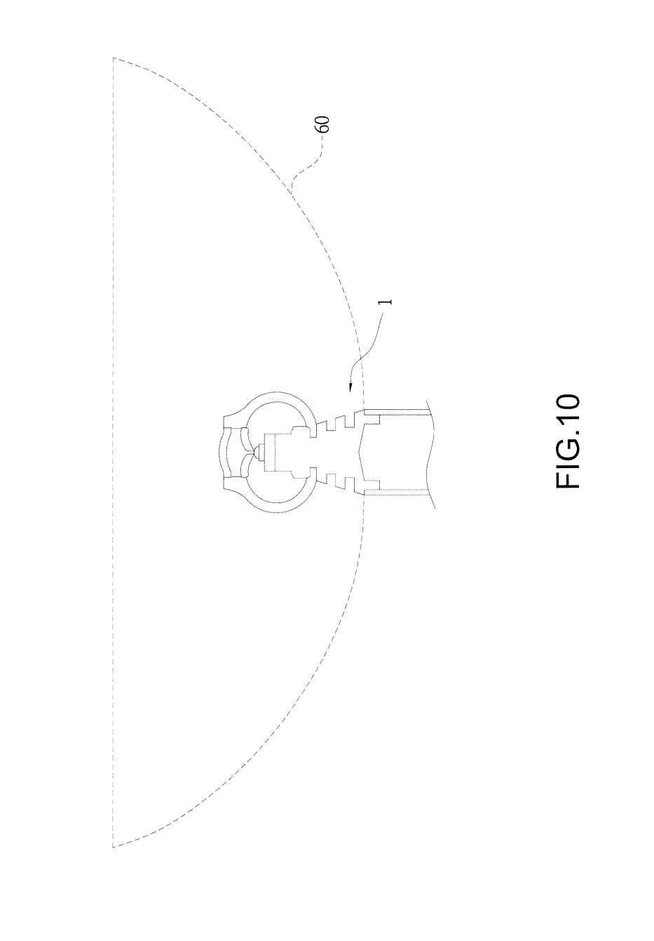

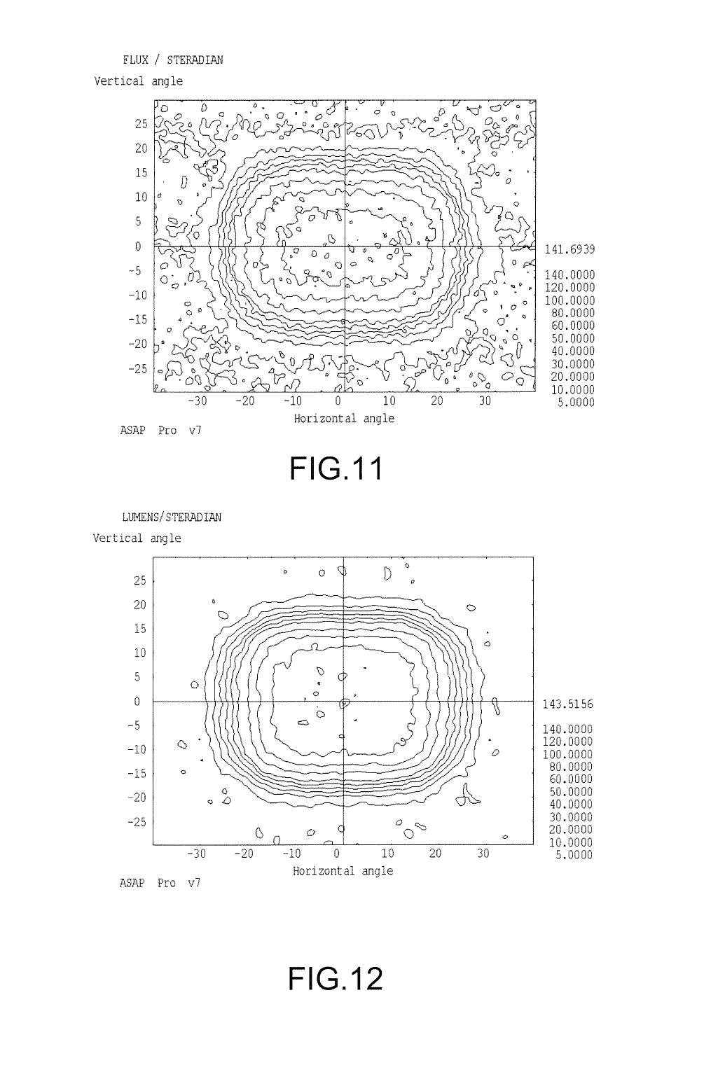

Please refer to FIGS. 10 to 12. FIG. 10 is a schematic illustration showing the use of the embodiment of the invention applied to a lamp reflector 60, such as the structure of a vehicle lamp reflector, wherein the reflective structure on the inner side of the lamp reflector 60 focuses the light rays, emitted from the tungsten-filament-like LED lamp structure of this embodiment, into the same direction to provide the aspect similar to the application of the conventional tungsten filament lamp. FIGS. 11 and 12 are isocandela diagrams obtained after experimental simulations when the conventional tungsten filament lamp and the tungsten-filament-like LED lamp structure of this embodiment are mounted in the same lamp reflector 60. As shown in FIGS. 11 and 12, it is clearly obtained that the tungsten-filament-like LED lamp structure of this embodiment can indeed generate the optical field similar to that of the conventional tungsten filament lamp, so that the electrical energy loss can be effectively decreased and the energy saving can be achieved.

As mentioned hereinabove, the tungsten-filament-like LED lamp structure of the invention can use the single LED to generate the optical field similar to that of the conventional tungsten filament lamp, and can be applied to various conventional lamps. Thus, the invention can indeed decrease the manufacturing cost and the maintenance cost of the lamp, increase the lifetime and energy saving effect, and thus satisfy the industrial utility, novelty and inventive step.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A tungsten-filament-like light-emitting diode (LED) lamp structure, comprising:
a LED substrate having a bottom surface combined with a top portion of a heat dissipating frame;
a lamp shade having a bottom portion combined with the heat dissipating frame so that the LED substrate is disposed in the lamp shade;
a LED light source disposed on a surface of the LED substrate; and
a light spreader assembly, which is combined with a combination portion of a top portion of the lamp shade and for spreading light rays, emitted from the LED light source, to have a light-emitting property similar to a light-emitting property of a tungsten filament light source, the light spreader assembly comprising:
a reflective device, which is disposed above the LED substrate, has a light-permeable portion at a position corresponding to the LED light source, and has a plurality of reflective surfaces between the light-permeable portion and a periphery of the reflective device;
a diverging element, which is disposed above the reflective device and for diverging an angle of light rays emitted from the light-permeable portion; and
a lamp holder combined with a bottom portion of the heat dissipating frame, wherein a circuit board electrically connected to the LED substrate is disposed in the lamp holder.

2. The tungsten-filament-like LED lamp structure according to claim 1, wherein each of the reflective surfaces is an outwardly projecting camber, a concave camber or a plane.

3. The tungsten-filament-like LED lamp structure according to claim 2, wherein the number of the reflective surfaces ranges from 2 to 8.

4. The tungsten-filament-like LED lamp structure according to claim 3, wherein the reflective surface or each of the reflective surfaces near the light-permeable portion is the outwardly projecting camber.

5. The tungsten-filament-like LED lamp structure according to claim 3, wherein the reflective surface or each of the reflective surfaces near the periphery of the reflective device is the concave camber.

6. The tungsten-filament-like LED lamp structure according to claim 1, wherein the light-permeable portion is a circular or elliptic through hole or transparent layer, and the light-permeable portion rests against or extremely approximate a top end of the LED light source.

7. The tungsten-filament-like LED lamp structure according to claim 6, wherein the heat dissipating frame is a substantially conical bracket, and has a top portion, a bottom portion and a plurality of heat dissipating layers disposed between the top portion and the bottom portion, and an outer diameter of each of the heat dissipating layers is relatively smaller than an outer diameter of the heat dissipating layer therebelow.

8. The tungsten-filament-like LED lamp structure according to claim 7, wherein the LED light source further comprises a primary LED light source and a plurality of secondary LED light sources, the primary LED light source is disposed at a middle of the LED substrate and corresponds to the light-permeable portion, and the secondary LED light sources are disposed around the primary LED light source in an equally spaced manner.

9. The tungsten-filament-like LED lamp structure according to claim 8, wherein the bottom portion of the lamp shade is formed with a positioning hole for fitting with and being fixed to the heat dissipating frame.

10. The tungsten-filament-like LED lamp structure according to claim 9, wherein the combination portion is a receptacle extending inwardly from the top portion of the lamp shade and is for accommodating the light spreader assembly, and the combination portion comprises at least one fitting slot for fitting with the reflective device or the diverging element.

11. The tungsten-filament-like LED lamp structure according to claim 10, wherein the diverging element is combined with a corresponding position of the top portion of the lamp shade, and the lamp shade is composed of a left lamp shell and a right lamp shell.

12. The tungsten-filament-like LED lamp structure according to claim 10, wherein the lamp shade is composed of a housing and a cover, the combination portion is located at a position corresponding to the cover, and the diverging element is combined with the cover.

13. The tungsten-filament-like LED lamp structure according to claim 3, wherein the light-permeable portion is a circular or elliptic through hole or transparent layer, and the light-permeable portion may rest against or extremely approximate a top end of the LED light source.

14. The tungsten-filament-like LED lamp structure according to claim 13, wherein the heat dissipating frame is a substantially conical bracket, and has a top portion, a bottom portion and a plurality of heat dissipating layers disposed between the top portion and the bottom portion, and an outer diameter of each of the heat dissipating layers is relatively smaller than an outer diameter of the heat dissipating layer therebelow.

15. The tungsten-filament-like LED lamp structure according to claim 14, wherein the LED light source further comprises a primary LED light source and a plurality of secondary LED light sources, the primary LED light source is disposed at a middle of the LED substrate and corresponds to the light-permeable portion, and the secondary LED light sources are disposed around the primary LED light source in an equally spaced manner.

16. The tungsten-filament-like LED lamp structure according to claim 15, wherein the bottom portion of the lamp shade is formed with a positioning hole for fitting with and being fixed to the heat dissipating frame.

17. The tungsten-filament-like LED lamp structure according to claim 16, wherein the combination portion is a receptacle extending inwardly from the top portion of the lamp shade and is for accommodating the light spreader assembly, and the combination portion comprises at least one fitting slot for fitting with the reflective device or the diverging element.

18. The tungsten-filament-like LED lamp structure according to claim 17, wherein the diverging element is combined with a corresponding position of the top portion of the lamp shade, and the lamp shade is composed of a left lamp shell and a right lamp shell.

19. The tungsten-filament-like LED lamp structure according to claim 17, wherein the lamp shade is composed of a housing and a cover, the combination portion is located at a position corresponding to the cover, and the diverging element is combined with the cover.
